(19) United States
(12) Patent Application Publication
(10) Pub. No.: US 2024/0306684 A1
(43) Pub. Date: Sep. 19, 2024

(54) METHOD OF MAKING A CONDIMENT

(71) Applicant: John A, Moore, JR., Carmel, IN (US)

(72) Inventor: John A, Moore, JR., Carmel, IN (US)

(21) Appl. No.: 18/122,580

(22) Filed: Mar. 16, 2023

(51) Int. Cl. A23L 27/14; A23B 7/02; A23L 19/00

(52) U.S. Cl. CPC A23L 27/14; A23B 7/0215; A23L 19/01

(57) ABSTRACT

A method of making a condiment is provided including slicing a pepper into pepper halves, placing the pepper halves onto a tray, dehydrating the pepper halves, placing the pepper halves within a container, and crushing the pepper halves within the container using a crushing object. The pepper is sliced lengthwise from a first end to a second end, dividing the pepper into the first half along a first sliced surface of the first half and a second sliced surface of the second half. The pepper halves are placed in the tray such that the first sliced surface and the second sliced surface are positioned upward relative to the tray. The pepper fragments are crushed such that the container includes pepper fragments smaller than 0.25 inches and pepper fragments which are larger than 0.25 inches.

### TECHNICAL FIELD

This disclosure relates to a condiment including dried peppers and a method making said condiment.

### BACKGROUND

The statements in this section merely provide background information related to the present disclosure and may not constitute prior art.

Condiments such as salt, pepper, and chili powder are frequently added to food to enhance flavor. However, frequently, condiment manufacturing methods typically grind the condiment to very small grain sizes such that the seasoning may be added to the food resulting a consistent and predictable enhancement of the flavor of the food and resulting in minimal change to the texture of the food. Especially with chili peppers, it is desirable to have a condiment available which has larger grain sizes such that the seasoning may be added to the food to enhance the texture of food, and also produce an unpredictable variation in the enhancement of the flavor of the food.

### SUMMARY

Further areas of applicability will become apparent from the description provided herein. It should be understood that the description and specific examples are intended for purposes of illustration only and are not intended to limit the scope of the present disclosure.

In one embodiment, a method of making a condiment is provided including slicing a pepper, placing a first half of a pepper and a second half of a pepper on a tray, dehydrating the first half and the second half, placing the first half and the second half within a container, and crushing the first half and the second half within the container using a crushing object. The pepper is sliced lengthwise from a first end to a second end, dividing the pepper into the first half along a first sliced surface of the first half and a second sliced surface of the second half. The first half and the second half are placed in the tray such that the first sliced surface and the second sliced surface are positioned upward relative to the tray. The pepper fragments are crushed such that the container includes pepper fragments smaller than 0.25 inches and pepper fragments which are larger than 0.25 inches.

In yet another embodiment, a method of making a condiment is provided including placing a plurality of peppers onto a tray, dehydrating the plurality of peppers, placing each of the plurality of peppers into a container, and crushing the plurality of peppers within a container using a cylindrical crushing object. The cylindrical crushing object has an outer surface configured to crush the plurality of peppers into pepper fragments varying in size from between 0.031 inches to 1.000 inches.

In another embodiment, a method of making a condiment is provided including dehydrating a plurality of peppers, placing the plurality of peppers into a container positioned along a conveyance system, and crushing the plurality of peppers. The plurality of peppers are crushed using a plurality of crushing objects as the plurality of peppers are advanced along the conveyance system. Each of the plurality of crushing objects has a crushing surface adapted to crush each of the plurality of peppers into pepper fragments varying in size from 0.031 inches to 1.000 inches.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a side plan view of a first example of a pepper;

FIG. 2 illustrates a side plan view of a second example of a pepper;

FIG. 3 illustrates a side view of a first example of a sliced pepper;

FIG. 4 illustrates a plan view of a first example of a dehydration tray;

FIG. 5 illustrates a cross-sectional side view of a first example of a container including pepper fragments;

FIG. 6 illustrates a cross-sectional side view of a first example of a crushing apparatus including a crushing object, a container, and pepper fragments.

FIG. 7 illustrates a perspective view of a first example of a crushing object.

FIG. 8 illustrates a cross-sectional side view of a second example of a crushing apparatus including crushing objects, and a conveyance system.

FIG. 9 illustrates a flow diagram illustrating a method of making a condiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In one example, a method of making a condiment is provided including slicing a pepper, placing a first half of a pepper and a second half of a pepper on a tray, dehydrating the first half and the second half, placing the first half and the second half within a container, and crushing the first half and the second half within the container using a crushing object. The pepper is sliced lengthwise from a first end to a second end, dividing the pepper into the first half along a first sliced surface of the first half and a second sliced surface of the second half. The first half and the second half are placed in the tray such that the first sliced surface and the second sliced surface are positioned upward relative to the tray. The pepper fragments are crushed such that the container includes pepper fragments smaller than 0.25 inches and pepper fragments which are larger than 0.25 inches.

One technical advantage of the systems and methods described below may be that a method may be used to produce a condiment having a variety of grain sizes. Especially the larger grain flakes of the condiment may enhance the texture of the food it is applied to as well enhance the flavor. Furthermore, the variety of grain sizes of the condiment may produce an unpredictable variation in the enhancement of the flavor, leading to a more enjoyable dining experience.

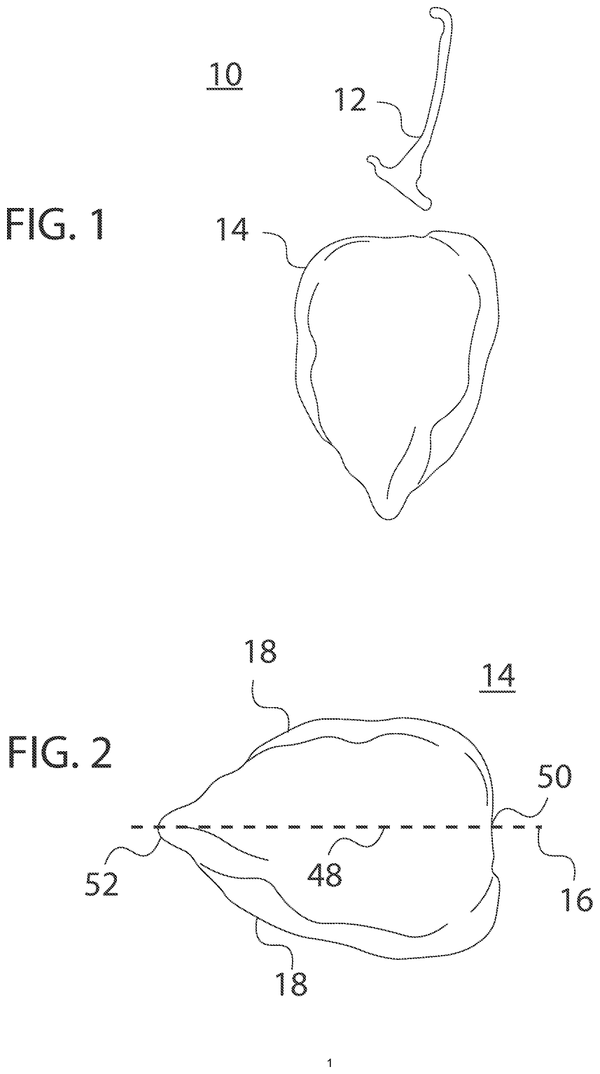

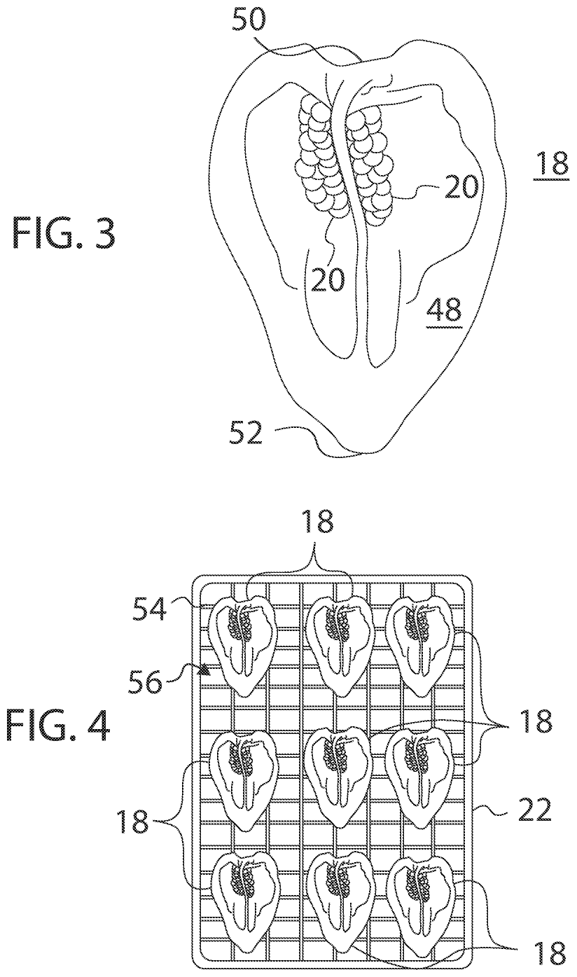

FIG. 1 illustrates a cross-sectional side view of a first example of a pepper 10 including a stem 12 and a body 14. The pepper 10 may be the fruit of any plant within the Capsicum genus which can be broken into pieces at least 1 inch in length. Examples of the pepper 10 may include bell peppers, jalapenos, banana peppers, habanero peppers, and cayenne peppers. The stem 12 of the pepper 10 may be any portion of the pepper 10 which connected the pepper 10 to its parent plant. The body 14 of the pepper 10 may be any portion of the pepper 10 which contains seeds (20 in FIG. 3). As illustrated in FIG. 1, the stem 12 may be separated from the body 14 of the pepper 10 before any other preparation of the condiment may occur. The stem 12 may be separated by manually pulling the stem 12 from the body 14 or by slicing the stem 12 off of the body 14. The stem 12 may be discarded after being removed from the body 14.

FIG. 2 illustrates a side view of another example of the pepper 10. The pepper 10 may be sliced lengthwise from a first end 50 to a second end 52 to divide the pepper 10 into pepper halves 18, a first pepper half 18 and a second pepper half 18. The first end 50 of the pepper 10 may be located at the point from which the stem was removed. The second end 52 of the pepper 10 may be located along the length of the pepper 10 opposite from the first end 50, typically at a point where the body 14 of the pepper 10 tapers to a point. The slicing of the pepper 10 may occur along a slicing axis 16 which extends from the first end 50 to the second end 52 of the pepper 10. After slicing, each pepper half 18 may have a slicing surface 48 which is planar, extending along the slicing axis 16.

The pepper half 18 may be any portion of the pepper 10 which is obtained from slicing the pepper 10. In some embodiments, the pepper half 18 may be less than or more than half of the pepper 10. For example, the pepper 10 may be sliced into two roughly equal portions along a single slicing axis 16. In another example, the pepper 10 may be sliced into three or four portions along two or more slicing axes 16.

FIG. 3 illustrates a side view of an example of the pepper half 18. The sliced pepper 10 exposes the seeds 20 of the pepper 10. These seeds 20 may be removed prior to dehydration of the pepper halves 18. Retaining or removing the seeds 20 may alter the taste and texture of the condiment. For example, for some peppers 10, retaining the seeds 20 may increase the amount of capsicum in the condiment, increasing the piquancy of the condiment.

FIG. 4 illustrates a top-down view of an example of a tray 22 including a number of pepper halves 18. After slicing, the pepper halves 18 may be placed on the tray 22. The sliced surfaces 48 of the pepper halves 18 may be positioned upward relative to the tray to minimize contact between the pepper 10 and the tray 22. The tray 22 may be any surface or container upon which one or more pepper halves 18 may be placed. In some embodiments, the tray may have a mesh surface 54 to allow air to circulate around the pepper halves 18 to allow even dehydration of the pepper halves 18.

The mesh surface 54 may include openings 56 which are as large as possible to minimize contact between the pepper halves 18 and the tray 22 while still preventing the pepper halves 18 from falling through the tray 22. Furthermore, during dehydration, the size of the pepper halves 18 may decrease as the moisture is evacuated from the pepper halves 18. As a result, the openings 56 may be sized to prevent the smaller dehydrated peppers halves 18 from falling through the tray 22. For example, in some embodiments, the openings 56 may have a cross-sectional area which is between 10% and 40% of a cross-sectional area of each of the pepper halves 18. In other embodiments, the surface 54 of the tray 22 may include a grid defining a plurality of open cells.

Once arranged on the tray 22, the pepper halves 18 may be placed within a chamber of a food dehydrator (not shown). The chamber of the food dehydrator may be heated to a temperature of between 130 degrees Fahrenheit to 160 degrees Fahrenheit. The pepper halves 18 may remain in the chamber of the food dehydrator for at least 15 hours but no more than 22 hours. The time and temperature necessary to dehydrate the pepper halves 18 may vary depending upon the ambient temperature and humidity. The pepper halves 18 may be removed from the chamber of the food dehydrator once the pepper halves 18 have become sufficiently dry and brittle that they may be easily broken apart. Dehydrating the pepper halves 18 for too long or at too high a temperature may burn the pepper halves 18. Portions of the pepper halves 18 in contact with the tray 22 may retain some moisture and may not therefore be brittle. These portions may be discarded.

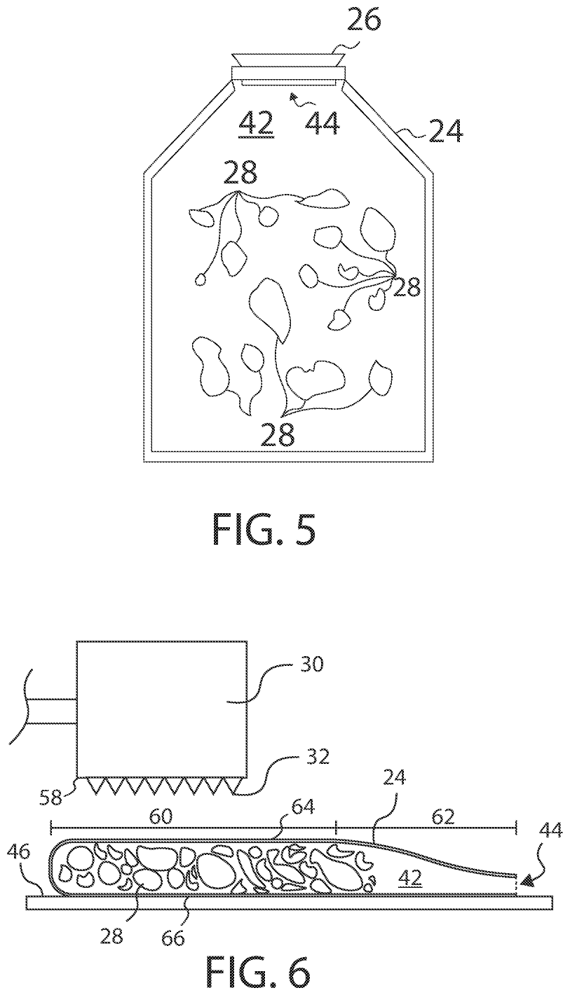

FIG. 5 illustrates a side cross-sectional view of an example of a container 24 container pepper fragments 28. The container 24 may be any flexible vessel having an interior space 42 adapted to contain the dehydrated pepper halves 18 and pepper fragments 28. Examples of the container 24 may include a bag, a sleeve, or a cloth. The container 24 may be made of plastic, cloth, or a mesh. The container 24 may have an opening 44 by which the dehydrated pepper halves 18 may be inserted into the interior space 42 and by which the pepper fragments 28 may be removed from the interior space 42. While in the container 24, the pepper halves 18 may be crushed into the pepper fragments 28 having a size varying between 0.031 inches to 1.000 inches. The size of the fragments may be defined as the largest dimension of the pepper fragment, for example, length, width, or thickness. After crushing, the container 24 may include pepper fragments 28 which are smaller than 0.25 inches and pepper fragments 28 which are larger than 0.25 inches. In some embodiments, after crushing, the container 24 may contain a plurality of pepper fragments 28 having a size of at least 0.5 inches.

In some embodiments, the opening 44 may include a seal 26. The seal 26 may be anything which prevents pepper fragments 28 from escaping from the interior space 42. Examples of the seal may include a zipper, a stopper, or an interlocking set of ridges along the interior of the container 24. In some embodiments, the seal 26 may be used to control the volume of the interior space 42 by controlling the amount of air within the interior space. For example, in some embodiments, the seal may be air-tight, such that when the container 24 is sealed, air cannot enter or exit the interior space 42 through the opening 44. In such embodiments, the volume of the interior space 42 may be partially evacuated before sealing the opening 44 to obtain optimal conditions for crushing the fragments. For example, if the interior space 42 is sealed with too great a volume from excessive air, the pepper halves 18 may be prevented from being crushed into sufficiently small pepper fragments 28. In such an embodiment, the excessive air may provide a large cushion to the pepper halves 18, preventing sufficient crushing from contact with a crushing object (30 in FIG. 6). Similarly, if the interior space 42 is sealed while with too little volume from insufficient air, the pepper halves 18 may be crushed into too small of pepper fragments 28. In such an embodiment, the insufficient air within the interior space 42 may provide too small a cushion to the pepper halves 18, causing the crushing object 30 to crush them into pepper fragments 28 have too fine of a grain.

FIG. 6 illustrates a cross-sectional view of another example of the container including pepper fragments 28 and the crushing object 30. The crushing object 30 may be any implement which may be used to crush and break down the pepper halves 18 in the container 24 into pepper fragments 28. Examples of the crushing object 30 may include a mallet, a roller, or even a foot. In some embodiments, the crushing object 30 may be brought forcefully down upon the container 24 to crush the pepper halves 18.

The crushing object 30 may include a crushing surface 58 which contacts the pepper halves 18 to break them up. The crushing surface 58 may be any portion of the crushing object 30 by which force is transferred from the crushing object 30 to the pepper halves 18. For example, if the crushing object 30 were a cube, and one face of the cube was used to crush the pepper halves 18, the crushing surface 58 may be the face of the cube which faces the pepper halves 18 and which would exert force upon the pepper halves 18. Alternatively, if the crushing object 30 were a cylinder, the crushing surface 58 may be the half of the cylinder which faces the pepper halves 18 and which would exert force upon the pepper halves 18.

In some embodiments, the crushing surface 58 may be textured to allow for uneven crushing of the pepper halves 18. For example, the crushing surface 58 may include a series of ridges, bumps, or protruding spikes. Such an uneven crushing surface 58 may ensure that the crushing object 30 does not crushing the pepper halves 18 into pepper fragments 28 which are too fine, but instead creates pepper fragments 28 with a variety of shapes and sizes.

In some embodiments, the container 24 have a receiving surface 60 upon which the crushing object 30 may exert force. The receiving surface 60 may be any portion of the container under which pepper halves may be 18 positioned. The receiving surface 60 may generally be flat and may have a desired receiving surface area to ensure optimal crushing of the pepper halves 18. Similarly, the crushing surface 58 may have a cross-sectional surface area. The cross-sectional surface area may be defined as the area of the cross-section of crushing surface 58 which interacts with the flat receiving surface 60. In some embodiments, the pepper halves 18 may be crushed optimally when the cross-sectional surface area of the crushing surface 58 is at least 25% of the receiving surface area of the receiving surface 60.

In some embodiments, the container 24 may have an opening 44 which is open and unsealed and in communication with the atmosphere. An unsealed opening 44 may allow air to flow freely into and out of the interior space 42 as the crushing object 30 crushes the pepper halves 18, and in some embodiments may be preferable to achieve the desired sizes and varieties of pepper fragments 28. In such embodiments, the container 24 may include an excess surface 62 which extends beyond the receiving surface 60 to the opening 44. The excess surface 62 may allow pepper fragments 28 to migrate freely within the interior space 42 and may prevent excessive crushing of the pepper halves 18 from being too close together as they are crushed. The crushing object 30 may be used against the excess surface 62 as well to sufficiently crush any fragments that have migrated under it which are too large.

In some embodiments, the container 24 may be placed on an impact resistant base 46 during the crushing of the pepper halves 18. The impact resistant base 46 may be any object upon which the container 24 may rest which may absorb a portion of the force delivered to the container 24 by the crushing object 30. Examples of the impact resistant base 46 may include a rubber mat, a foam insulating layer, or a portion of carpet. The impact resistant base 46 may further assist in achieving the desired sizes and varieties of pepper fragments 28 by absorbing some of the force of the crushing object 30 as it is brought down upon the container 24.

In some embodiments, the pepper halves 18 may be crushed on a first side of the container 24 to break apart the pepper halves 18. Subsequently, the container 24 may be turned such that the first side of the container 24 faces away from the crushing object 30 and such that a second side faces the crushing object 30. The pepper halves 18 may then be crushed on the second side of the container 24 to ensure that the sizable portions of the pepper halves 18 have been sufficiently crushed.

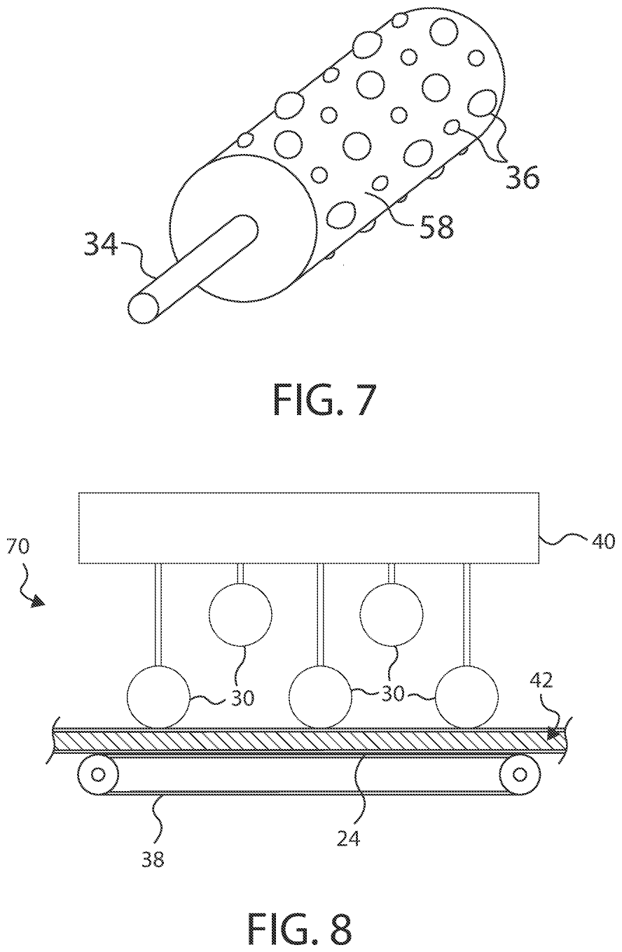

FIG. 7 illustrates a perspective view of an example of the crushing object 30. In some embodiments, the crushing object 30 may have a cylindrical shape. Furthermore, the crushing object 30 may include a handle 34. The handle 34 may be any portion of the crushing object 30 which may be gripped by an operator. As illustrated in FIG. 7, the crushing object 30 may include several nubs 36 protruding from the crushing surface 58. The nubs 36 may have a variety of sizes and shapes to ensure uneven crushing of the pepper halves 18. In some embodiments, the nubs 36 may extend outwardly from the crushing surface 58 at a variety of distances. For example, some of the nubs 36 may extend at least 0.125 inches outwardly from the crushing surface 58, and some of the nubs 36 may extend no more than 0.375 inches outwardly from the crushing surface 58.

Furthermore, the nubs 36 may be arranged in patterns to ensure uneven crushing of the pepper halves 18. For example, in some embodiments, the nubs 36 may be arranged on the crushing surface to be evenly spaced about a circumference of the crushing surface 58. In the embodiment of a cylindrical crushing object 30, the crushing object 30 may be rolled over the container 24, allowing the nubs 36 to unevenly exert force on the pepper halves 18, ensuring pepper fragments 28 with a variety of sizes.

FIG. 8 illustrates a cross-sectional side view of an example of a crushing apparatus 70. The crushing apparatus 70 may be any apparatus that crushes the peppers halves 18 within the container 24 into pepper fragments 28 in a motorized or mechanized process. The crushing apparatus 70 may be automated or semi-automated, requiring little to no user action. The crushing apparatus 70 may include a conveyance system 38 and one or more crushing objects 30. The conveyance system 38 may be any device upon which the pepper halves 18 may be advanced along a path during the crushing process. Examples of the conveyance system 38 may include a conveyer belt, a chute, or a set of rollers. The conveyance system 38 may be motorized, gravity driven, pressure driven, or hand operated. The pepper halves 18 may be placed in the container 24 and advanced along the conveyance system. In some embodiments, the container 24 may be a bag or other loosely enclosed space, similar to the containers shown in FIGS. 5 and 6. In other embodiments, the container 24 may be a set of sidewalls placed over the conveyance system 38 to prevent the pepper halves 18 from falling off the conveyance system 38.

The crushing objects 30 may be spaced out along the path of the conveyance system 38 to crush the pepper halves 18 within the container 24. The crushing objects 30 may be operated by one of more hubs 40. The hub 40 may be any system which can mechanically drive the crushing objects 30 to crush the pepper halves 18 on the conveyance system. The hub 40 may be motorized or hand operated.

To ensure that the pepper halves 18 are properly crushed, the depth of the pepper halves 18 within the container 24 should be managed. For example, the pepper halves 18 within the container may have a depth of at least 1 inch. Furthermore, the pepper halves 18 within the container may have a depth of no more than 3 inches.

In some embodiments, the process may include sifting out pepper fragments 28 which are too small. For example, in some embodiments, pepper fragments 28 smaller than 0.031 inches may be discarded. The sifting may occur after the crushing process or during the crushing process. For example, in some embodiments, the conveyance system 38 may have small openings to allow the undesired smaller pepper fragments 28 to be sifted out as the pepper halves 18 are being crushed.

In some embodiments, the crushing process may include mixing the partially pepper halves 18 within the container 24 after an initial crushing. The pepper halves 18 may then be crushed a second time to ensure a more thorough crushing process. This step may be repeated as many times as necessary to achieve the desired results.

Furthermore, although specific components are described above, methods, systems, and articles of manufacture described herein may include additional, fewer, or different components. For example, more than one crushing object 30 may be used to crush the pepper halves 18 within the container 24.

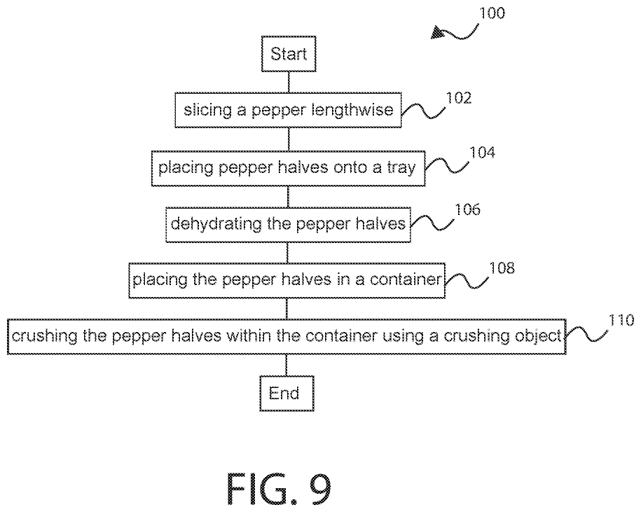

FIG. 9 illustrates a flow diagram of operations to make a condiment. The operations may include fewer, additional, or different operations than illustrated in FIG. 9. Alternatively or in addition, the operations may be performed in a different order than illustrated.

The condiment may be made through a preparation process (100). Initially, the pepper 10 may be sliced lengthwise, dividing the pepper 10 into two pepper halves 18 (102). Each of the pepper halves 18 may be placed onto a tray 22 (104). The pepper halves 18 may then be dehydrated (106). The pepper halves 18 may then be placed within a container 24 (108). The pepper halves 18 may then be crushed into pepper fragments 28 within the container 24 using a crushing object 30 (110).

In addition to the advantages that have been described, it is also possible that there are still other advantages that are not currently recognized but which may become apparent at a later time. While various embodiments have been described, it will be apparent to those of ordinary skill in the art that many more embodiments and implementations are possible. Accordingly, the embodiments described herein are examples, not the only possible embodiments and implementations.

What is claimed is:

1. A method of making a condiment comprising:
slicing a pepper lengthwise from a first end to a second end, dividing the pepper into a first half and a second half along a first sliced surface of the first half and a second sliced surface of the second half;
placing each of the first half and the second half onto a tray, wherein the first sliced surface and the second sliced surface are positioned upward relative to the tray;
dehydrating the first half and the second half of the pepper;
placing each of the first half and the second half into a container; and
crushing the first half and the second half within the container using a crushing object having a crushing surface, wherein the pepper fragments are crushed such that the container includes pepper fragments smaller than 0.25 inches and pepper fragments which are larger than 0.25 inches.

2. The method of claim 1, wherein dehydrating the first half and the second half of the pepper includes placing the first half and the second half in a chamber of no more than 160 degrees Fahrenheit for no less than 15 hours.

3. The method of claim 2, wherein the container has a receiving surface area and a cross-sectional surface area of the crushing surface is at least 25% of the receiving surface area.

4. The method of claim 1, wherein the crushing object comprises a flat crushing surface configured to crush the first half and the second half into a plurality of pepper fragments.

5. The method of claim 1, wherein the tray comprises a surface containing grid defining a plurality of open cells.

6. The method of claim 1, wherein crushing the first half and the second half within the container further comprises:
crushing the first half and the second half on a first side of the container with the crushing object;
turning the container such that the first side of the container faces away from the crushing object; and
crushing the first half and the second half on a second side of the container with the crushing object.

7. The method of claim 1, further comprising placing the container on an impact resistant base before crushing the first half and the second half within the container with the crushing object.

8. The method of claim 1, further comprising:
evacuating air within the container before crushing the first half and the second half within the container with the crushing object; and
sealing the container before crushing the first half and the second half within the container with the crushing object.

9. The method of claim 1, wherein the container has a first end which is unsealed and in atmospheric communication during the crushing of the first half and the second half.

10. A method of making a condiment comprising:
placing a plurality of peppers onto a tray;
dehydrating the plurality of peppers;
placing each of the plurality of peppers into a container; and
crushing the plurality of peppers within the container using a cylindrical crushing object having a crushing surface adapted to crush the plurality of peppers into pepper fragments varying in size from 0.031 inches to 1.000 inches.

11. The method of claim 10, where the crushing object comprises a plurality of nubs extending outwardly from the crushing surface of the crushing object.

12. The method of claim 11, wherein the plurality of nubs are arranged on the crushing surface to be evenly spaced about a circumference of the crushing surface.

13. The method of claim 11, wherein the plurality of nubs extend a plurality of distances outwardly from the crushing surface of the crushing object.

14. The method of claim 13, wherein the plurality of nubs extend at least 0.125 inches outwardly from the crushing surface of the crushing object.

15. The method of claim 13, wherein the plurality of nubs extend no more than 0.375 inches outwardly from the crushing surface of the crushing object.

16. A method of making a condiment comprising:
dehydrating a plurality of peppers;
placing the plurality of peppers into a container positioned along a conveyance system; and
crushing the plurality of peppers using a plurality of crushing objects as the plurality of peppers are advanced along the conveyance system, wherein each of the plurality of crushing objects has a crushing surface adapted to crush each of the plurality of peppers into pepper fragments varying in size from 0.031 inches to 1.000 inches.

17. The method of claim 16, where the container is filled with peppers to a depth of at least 1 inch.

18. The method of claim 17, where the container is filled with peppers to a depth of no more than 3 inches.

19. The method of claim 16, further comprising sifting out pepper fragments smaller than 0.031 inches.

20. The method of claim 16, further comprising:
mixing the plurality of peppers within the container after crushing the plurality of peppers; and
crushing the plurality of peppers a second time using the plurality of crushing objects as the plurality of peppers are advanced along the conveyance system.
